(19) United States
(12) Patent Application Publication
(10) Pub. No.: US 2017/0094338 A1
(43) Pub. Date: Mar. 30, 2017

(54) INFORMATION PROCESSING APPARATUS AND DELIVERY METHOD

(71) Applicants: Takahiro KAMEKURA, Tokyo (JP); Yoshihiko SHIMOHIRA, Kanagawa (JP)

(72) Inventors: Takahiro KAMEKURA, Tokyo (JP); Yoshihiko SHIMOHIRA, Kanagawa (JP)

(21) Appl. No.: 15/274,319

(22) Filed: Sep. 23, 2016

(30) Foreign Application Priority Data
Sep. 28, 2015 (JP) 2015-190122

(51) Int. Cl. H04N 21/262; H04N 21/442; H04N 21/845; G06F 17/30; H04N 21/61

(52) U.S. Cl. CPC H04N 21/26258; G06F 17/3082; H04N 21/6125; H04N 21/845; H04N 21/44222; H04L 67/02

(57) ABSTRACT

An information processing apparatus, to which a client terminal is coupled, includes a segment generation unit configured to generate a first set of segments, in which content is divided into a plurality of first segments in accordance with a first time unit, and a second set of segments, in which the content is divided into a plurality of second segments in accordance with a second time unit, which is greater than the first time unit; a playlist generation unit configured to select one of the first segments and the second segments based on a reproduction history of the content in the client terminal, and generate a playlist including information on the selected segments; and a playlist delivery unit configured to deliver the playlist to the client terminal.

### CROSS-REFERENCE TO RELATED APPLICATIONS

The present application claims benefit of priority under 35 U.S.C. §119 of Japanese Patent Application No. 2015-190122, filed Sep. 28, 2015. The contents of this application are incorporated herein by reference in their entirety.

### BACKGROUND OF THE INVENTION

1. Field of the Invention

The disclosures herein generally relate to an information processing apparatus, and a delivery method.

2. Description of the Related Art

Systems that perform streaming deliveries for video have become popular in recent years. In such a streaming delivery, such as HLS (HTTP Live Streaming) or MPEG-DASH (Dynamic Adaptive Streaming over HTTP), the technique referred to as an HTTP adaptive streaming is known, in which a video is hashed into a plurality of files (segments) for predetermined time periods (e.g. every ten seconds) respectively and recorded, and the plurality of files are delivered to a client via communication by HTTP (Hypertext Transfer Protocol) (For example, see Japanese Unexamined Patent Application Publication No. 2013-038766).

In the technique disclosed in Japanese Unexamined Patent Application Publication No. 2013-038766, at first, the client acquires a playlist, in which an order of reproducing the segments is described, by an HTTP-GET request from a Web server. Then, the client sends to the Web server acquisition requests for the respective segments described in the playlist, by the HTTP-GET request. When the client serially acquires the segments from the Web server, the client reproduces the segments in the order described in the playlist.

FIG. 12 is a diagram depicting an example of files of the plurality of segments stored in the Web server and a file of the playlist, when the HLS is used. In the example illustrated in FIG. 12, a plurality of segments having file names of “movie00000.m2ts”, “movie00001.m2ts”, “movie00002.m2ts”, “movie00003.m2ts”, and “movie00004.m2ts” of the “MPEG-2 TS” format and a playlist having a file name of “playlist.m3u8” of the M3U8 format are stored.

FIG. 13 is a diagram depicting an example of content described in the playlist, when the HLS is used. According to the playlist, the client acquires and reproduces the segment files in the order of “movie00000.m2ts”, “movie00001.m2ts”, “movie00002.m2ts”, “movie00003.m2ts”, and “movie00004.m2ts”.

### SUMMARY OF THE INVENTION

It is a general object of at least one embodiment of the present invention to provide an information processing apparatus, and a delivery method that substantially obviate one or more problems caused by the limitations and disadvantages of the related art.

In one embodiment, an information processing apparatus, to which a client terminal is coupled, includes a segment generation unit configured to generate a first set of segments, in which content is divided into a plurality of first segments in accordance with a first time unit, and a second set of segments, in which the content is divided into a plurality of second segments in accordance with a second time unit, which is greater than the first time unit; a playlist generation unit configured to select one of the first segments and the second segments based on a reproduction history of the content in the client terminal, and generate a playlist including information on the selected segments; and a playlist delivery unit configured to deliver the playlist to the client terminal.

### BRIEF DESCRIPTION OF THE DRAWINGS

Other objects and further features of embodiments will become apparent from the following detailed description when read in conjunction with the accompanying drawings, in which:

FIG. 1 is a diagram depicting a general arrangement of a delivery system according to an embodiment;

FIG. 2 is a diagram depicting an example of a hardware configuration of a server apparatus and a client terminal;

FIG. 3 is a functional configuration diagram depicting the delivery system according to the embodiment;

FIG. 4 is a diagram depicting an example of reproduction history information;

FIG. 5 is a diagram depicting an example of playlist generation information;

FIG. 6 is a diagram depicting a concept of segment information;

FIG. 7 is a sequence diagram depicting an example of a process of delivering playlists;

FIG. 8 is a flowchart depicting an example of a process of generating playlists;

FIGS. 9A to 9E are diagrams depicting an example of contents of playlists;

FIG. 10 is a sequence diagram depicting an example of a process of delivering a file of segments;

FIG. 11A is a diagram for explaining a delay of reproduction time according to the related art;

FIG. 11B is a diagram for explaining a delay of reproduction time according to the embodiment;

FIG. 12 is a diagram depicting an example of files of a segment and a file of a playlist; and

FIG. 13 is a diagram depicting an example of content described in a playlist when HLS is used.

### DESCRIPTION OF THE PREFERRED EMBODIMENTS

In the following, embodiments of the present invention will be described with reference to the accompanying drawings.

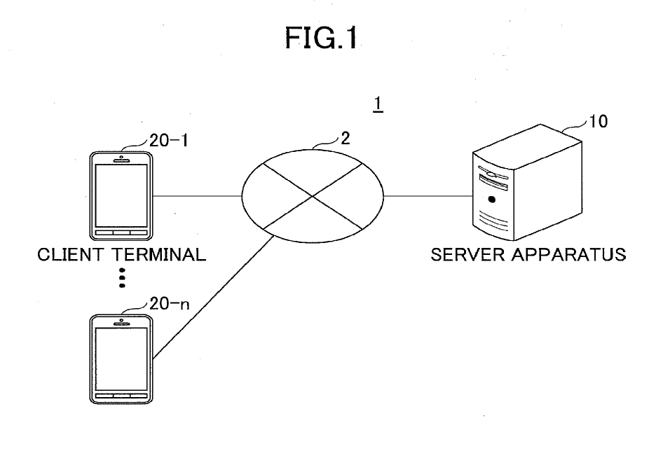

FIG. 1 is a diagram depicting a general arrangement of a delivery system 1 according to an embodiment. The delivery system 1 includes one or more server apparatuses 10 and a plurality of client terminals 20-1, 20-2, 20-n (in the following, will be properly called collectively “client terminals 20”). The server apparatuses 10 and the client terminals 20 are coupled to each other via a communication network 2 for a communications connection.

The server apparatus 10 is an information processing apparatus such as a Web server.

The client terminal 20 is an information terminal such as a smartphone, a tablet type terminal, or a personal computer.

The communication network 2 includes, for example, the Internet, a LAN, a wireless LAN, or a mobile telephone network.

In the delivery system 1 according to the embodiment, the server apparatus 10 preforms live streaming delivery of contents in response to a request from the client terminal 20. Then, contents of video and voice of a concert, a meeting, a monitor camera or the like are delivered to a plurality of client terminals 20 live (in real time). Specifically, the server apparatus 10 performs the following processes.

The server apparatus 10 generates a set of first segments obtained by dividing content into a plurality of segments in accordance with a first time unit, and a set of second segments obtained by dividing the content into a plurality of segments in accordance with a second time unit.

The server apparatus 10, based on a reproduction history for the content by the client terminal 20, selects one of the first segment and the second segment, generates a playlist including information of the selected segment, and delivers the playlist to the client terminal.

The client terminal 20 requests, for example, using a Web browser, the server apparatus 10 to deliver content, and reproduces the content delivered by streaming from the server apparatus 10.

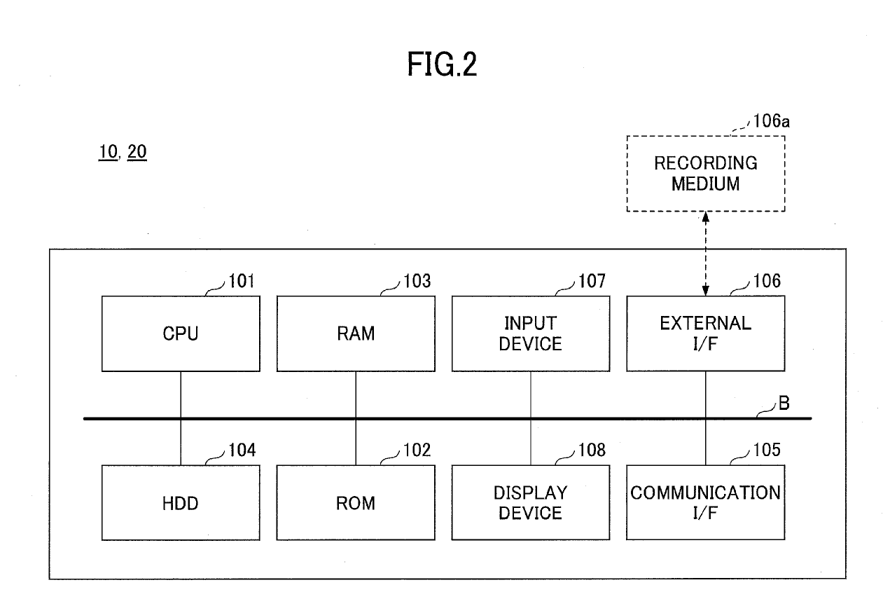

FIG. 2 is a diagram depicting an example of a hardware configuration of the server apparatus 10.

The server apparatus 10 includes a CPU (Central Processing Unit) 101, a ROM (Read Only Memory) 102, a RAM (Random Access Memory) 103, a HDD (Hard Disk Drive) 104, a communication interface (I/F) 105, an external I/F 106, an input device 107, a display device 108 and the like. The respective members are coupled to each other via a bus B.

The CPU 101 is an arithmetic device that reads out a program or data from a storage device such as the ROM 102 onto the RAM 103, executes a process, and thereby enables a control or a function of the overall server apparatus 10.

The ROM 102 is a non-volatile semiconductor memory (storage device) that can retain a program or data even when the power is off, and stores a program or data such as a BIOS, an OS configuration or the like.

The RAM 103 is a volatile semiconductor memory (storage device) that can temporarily retain a program or data.

The HDD 104 stores data such as the OS, or an application program that provides a variety of functions. Instead of the HDD 104, an auxiliary storage device such as an SSD (Solid State Drive) may be used.

The communication I/F 105 performs a communication in compliance with Ethernet (trademark registered).

The external I/F 106 is an interface with an external device. The external device includes a recording medium 106a or the like. The recording medium 106a can store a program that enables the embodiment. The server apparatus 10 can read out and/or write into the recording medium 106a via the external I/F 106.

The recording medium 106a is a recording medium such as an SD memory card. The recording medium 106a may be a USB (Universal Serial Bus) memory, a DVD (Digital Versatile Disk), a CD (Compact Disk), a flexible disk, or the like.

The program that enables the embodiment is, for example, stored in the recording medium 106a, and installed in the HDD 104 via the external I/F 106. When the program is downloaded from a network, the program is installed in the HDD 104 via the communication I/F 105.

The input device 107 is an interface for inputting various pieces of information to the server apparatus 10. The display device 108 displays various pieces of information that the server apparatus 10 retains.

A hardware configuration of the client terminal 20 is the same as the hardware configuration of the server apparatus 10.

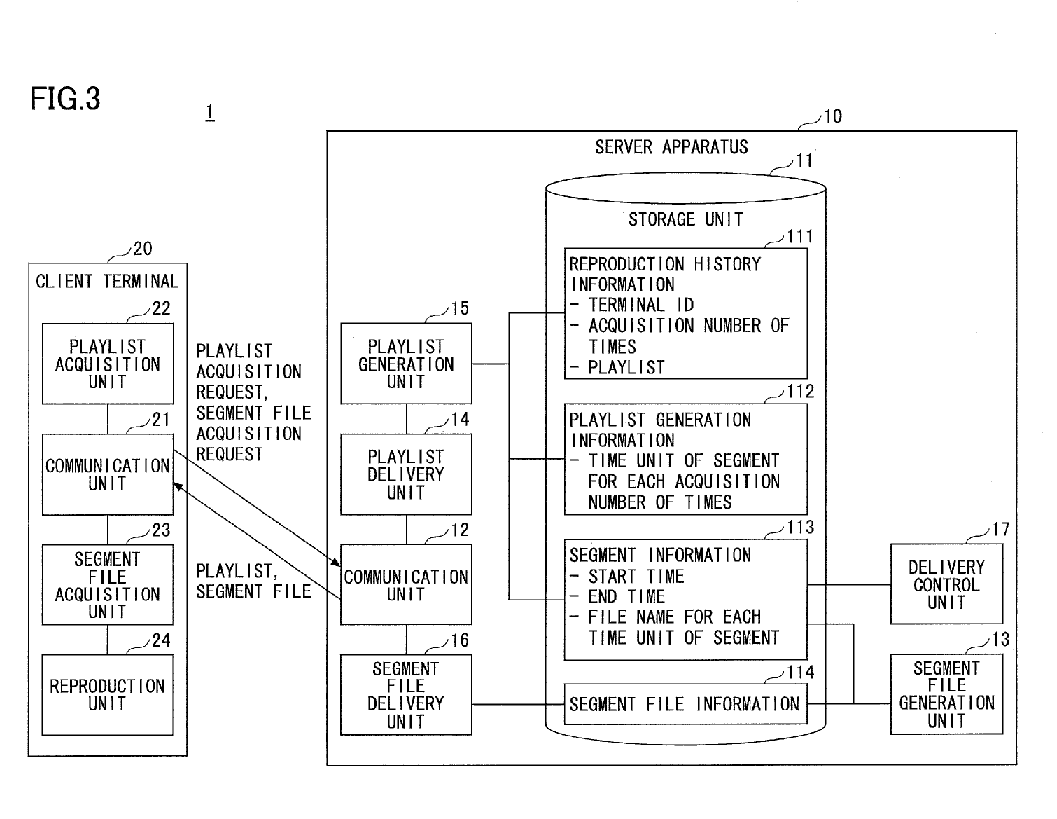

FIG. 3 is a functional configuration diagram depicting an example of the delivery system 1 according to the embodiment. The server apparatus 10 includes a storage unit 11, a communication unit 12, a segment file generation unit 13, a playlist delivery unit 14, a playlist generation unit 15, a segment file delivery unit 16 and a delivery control unit 17.

The storage unit 11 stores reproduction history information 111, playlist generation information 112, segment information 113 or segment file information 114.

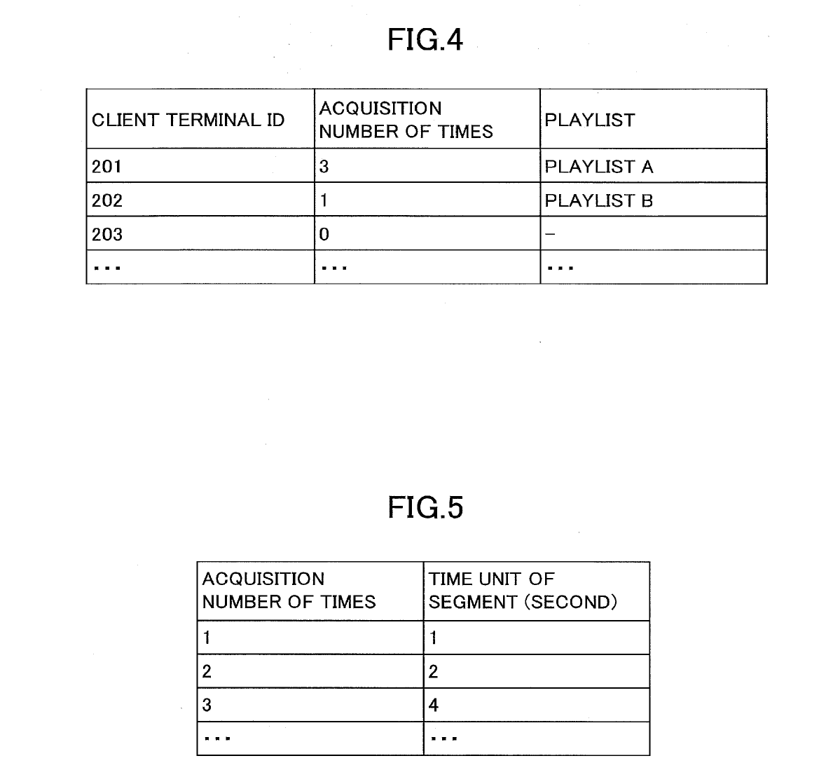

FIG. 4 is a diagram depicting an example of reproduction history information 111. The reproduction history information 111, as illustrated in FIG. 4, includes as items of data, a client terminal ID, an acquisition number of times, and a playlist. The client terminal ID is information for identifying the client terminal 20 or a user of the client terminal 20. As the client terminal ID, for example, data, such as “Cookie” or “Basic” authentication data, may be used.

The acquisition number of times is a number of times that the client terminal 20 acquires a playlist of content.

The playlist is information of the playlist that is generated finally and delivered to the client terminal 20.

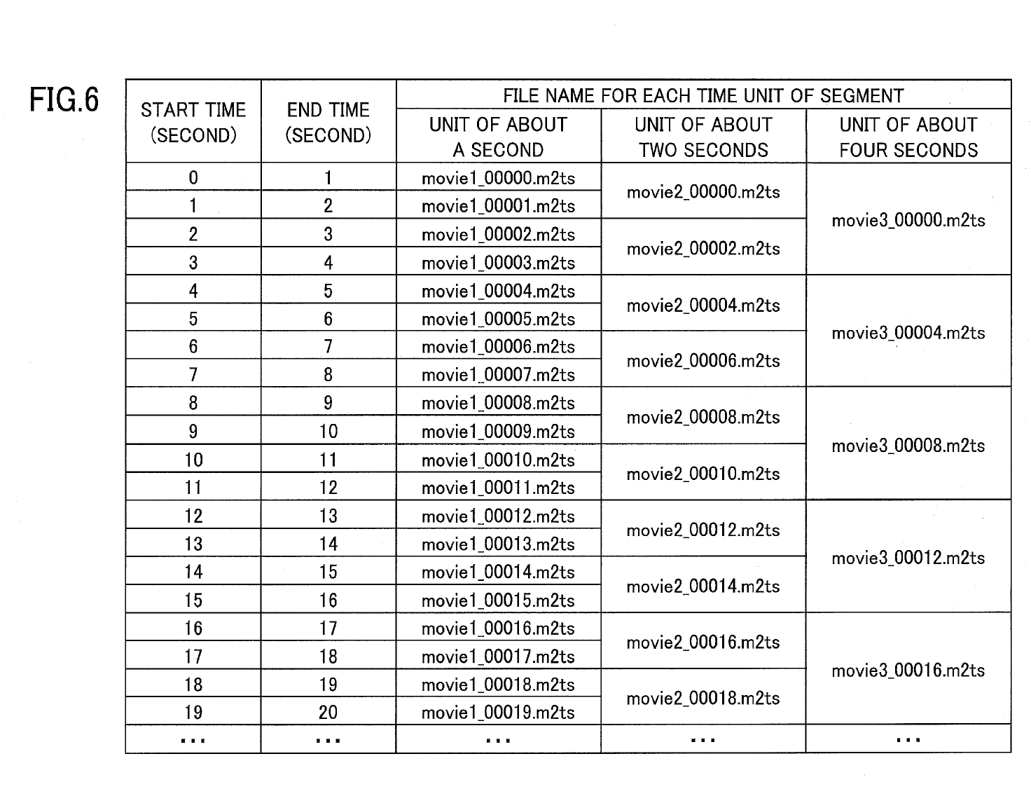

FIG. 5 is a diagram depicting an example of the playlist generation information 112. The playlist generation information 112 includes, as illustrated in FIG. 5, as items of data, an acquisition number of times, and information on a time unit of a segment. The time unit of the segment is a time period for reproducing content recorded in a file of the segment (time period from start of reproduction to end).

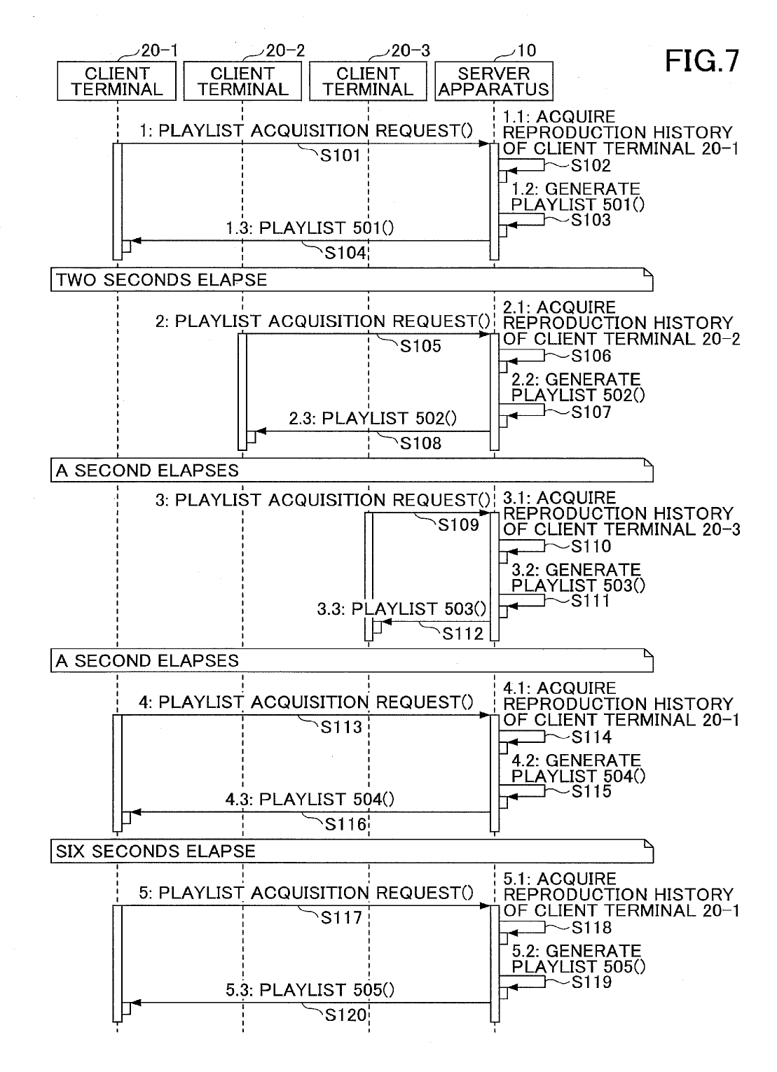

FIG. 6 is a diagram depicting a concept of segment information 113. The segment information 113 includes, as illustrated in FIG. 6, as items of data, start time (second), end time (second), and a file name for each time unit of segment.

The start time (second) is a start time of a video or the like recorded in a file of each segment in content that is delivered in real time (time period from the beginning of the content). The end time (second) is an end time of a video or the like recorded in a file of each segment in the content that is delivered in real time. For example, “movie1_00004.m2ts” in FIG. 6, where the start time is four seconds and the end time is five seconds, is a file of a segment, a reproduction time of which is one second, i.e. four seconds to five seconds from the beginning of the content.

The file name for each time unit of segment is a name of a file of a segment associated with a start time for each divided time unit.

The segment file generation unit 13 serially generates files of respective segments based on content that is delivered in real time. The delivery control unit 17 serially deletes files of old segments. Therefore, at a predetermined time, only parts of data, illustrated in FIG. 6, start times of which are close to the predetermined time are actually stored in the segment information 113.

The segment file information 114 is a piece of data of a file of a segment generated by the segment file generation unit 13.

The communication unit 12 performs communication with the client terminal 20, for example, by using HTTP.

The segment file generation unit 13 encodes content of a video, a sound or the like that is a delivery object and is input from an external device such as a camera, divides so that a key frame comes to the beginning at a position close to a plurality of predetermined time units (e.g. one second unit, two seconds unit, and four seconds unit), and thereby generates a file of segments. Specifically, the segment file generation unit 13 divides so that a start time and an end time of a file of the greater time unit (e.g. two seconds unit and four seconds unit) are equal respectively to a start time of the first file and an end time of the second file of the plurality of files of the smaller time unit (e.g. one second unit and two seconds unit, respectively), and thereby generates a file of segments. In the following, an example where the greater time unit is twice the smaller time unit will be described. However, the greater time unit may be three times the smaller time unit, or the greater time unit may be an integral multiple of the smaller time unit. In the case of three times, the file of segments is generated so that a length of a segment in the greater time unit is a length of three segments in the smaller time unit corresponding to the greater time unit.

The segment file generation unit 13 generates a file of segments using the standards of H.264 for video, AAC (Advanced Audio Coding) for voice, and MPEG-2 TS for container format.

The segment file generation unit 13 stores a start time (second), an end time (second) and a file name for each time unit of segments of the generated segment in the segment information 113, and stores the generated file of segments in the segment file information 114.

When receiving a playlist acquisition request from the client terminal 20, the playlist delivery unit 14 causes the playlist generation unit 15 to generate a playlist, and delivers (replies with) the generated playlist to the client terminal 20.

When the reproduction history of the client terminal 20 becomes greater than or equal to a predetermined threshold, the playlist generation unit 15 performs a playlist generation process of selecting longer segments, and generating a playlist in which a file of the selected segment is described. The playlist generation unit 15 generates a playlist of the M3U format if the streaming method is HLS or generates a playlist of the XML format if the streaming method is MPEG-DASH. The playlist generation process will be described later in detail.

When receiving an acquisition request from the client terminal 20, the segment file delivery unit 16 delivers a file of the required segment. For example, when receiving an acquisition request destined to a URI indicating an address of a file of the segment, a file of a segment associated with the URL is sent in reply.

The delivery control unit 17, in response to the present time, deletes from the segment information 113 a file of segment, a creation time of which is prior to the present time by a predetermined time period or more.

The delivery control unit 17, in response to the present time, deletes from the reproduction history information 111 a file of segment, a storage time of which is prior to the present time by a predetermined time period or more. For example, data, which are stored when the client terminal 20 finally acquires a playlist, are deleted when a predetermined time period (e.g. 60 seconds) elapses. Because the predetermine time period is set longer than a time until an acquisition request for playlist is sent again from the client terminal 20, a time period is set sufficiently longer than a sum of the reproduction time periods of the files of segments described in the above-described playlist.

The client terminal 20 is provided with a communication unit 21, a playlist acquisition unit 22, a segment file acquisition unit 23 and a reproduction unit 24.

The communication unit 21 performs communication with the server apparatus 10 using HTTP, for example.

When receiving an operation or the like from a user, the playlist acquisition unit 22 sends a playlist acquisition request to the server apparatus 10, by using the communication unit 21. The playlist acquisition unit 22 receives a response from the server apparatus 10, and acquires a playlist attached to the response.

Before completing reproduction of all segments described in the acquired playlist, by the reproduction unit 24 (for example, before starting reproducing the last segment described in the acquired playlist), the playlist acquisition unit 22 properly resends a playlist acquisition request, and reacquires (reloads) a playlist.

The playlist acquisition unit 22 ends reacquiring a playlist, when the acquired playlist includes a description indicating the last playlist (e.g. “*EXT-X-ENDLIST” tag defined in HLS).

The segment file acquisition unit 23 acquires files of segments in the order described in the playlist that the playlist acquisition unit 22 acquires. For example, the acquisition request is sent to a URI indicating an address of a file of a segment described in the playlist.

The reproduction unit 24 reproduces the files of segments that the segment file acquisition unit 23 acquires in the order of acquisition.

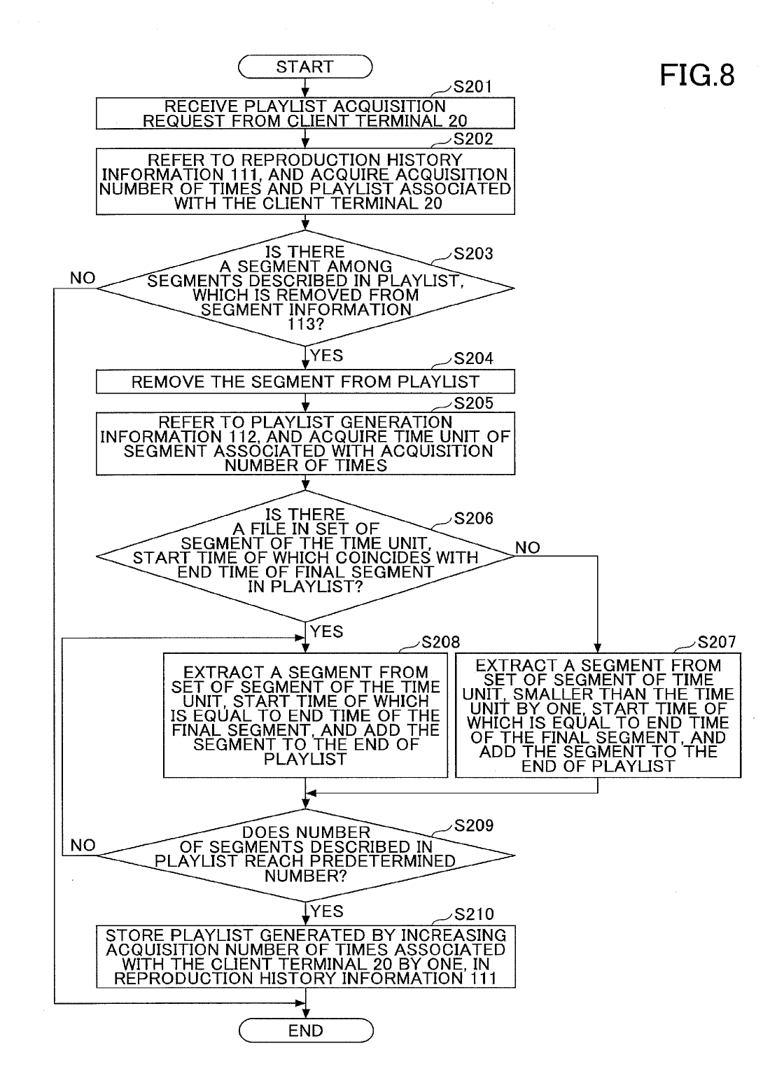

Next, with reference to FIG. 7, the operation of delivering playlists in the delivery system 1 according to the embodiment will be described. FIG. 7 is a diagram depicting an example of a sequence of delivering playlists in the delivery system 1 according to the embodiment. In the example of FIG. 7, contents are delivered by streaming in real time from the server apparatus 10 to the three client terminals 20-1, 20-2 and 20-3.

When the delivery of content starts, the client terminal 20-1 sends a playlist acquisition request to the server apparatus 10 in response to an operation or the like from a user (step S101).

The server apparatus 10 acquires a reproduction history of the client terminal 20-1 from the reproduction history information 111 by a playlist generation process (step S102), and generates a playlist 501 according to the acquired reproduction history or the like (step S103). Then, the generated playlist 501 is sent to the client terminal 20-1 (step S104).

The client terminal 20-2, after two seconds elapse, for example, acquires the playlist 502 according to the same processes as steps S101 through S104 (steps S105 through S108).

The client terminal 20-3, for example, further after a second elapses (i.e. when three seconds elapse after the delivery of content starts), similarly acquires the playlist 502 (steps S109 through S112).

The client terminal 20-1 similarly acquires a second playlist 504 further after a second elapses (i.e. when four seconds elapse after the delivery of content starts) (steps S113 through S116).

The client terminal 20-1 similarly acquires a third playlist 505 further after six seconds elapse (i.e. when ten seconds elapse after the delivery of content starts) (steps S117 through S120).

Similarly, in the following, the client terminals 20-1, 20-2, and 20-3 repeat reacquisition of playlists from the server apparatus 10 until the delivery of contents ends.

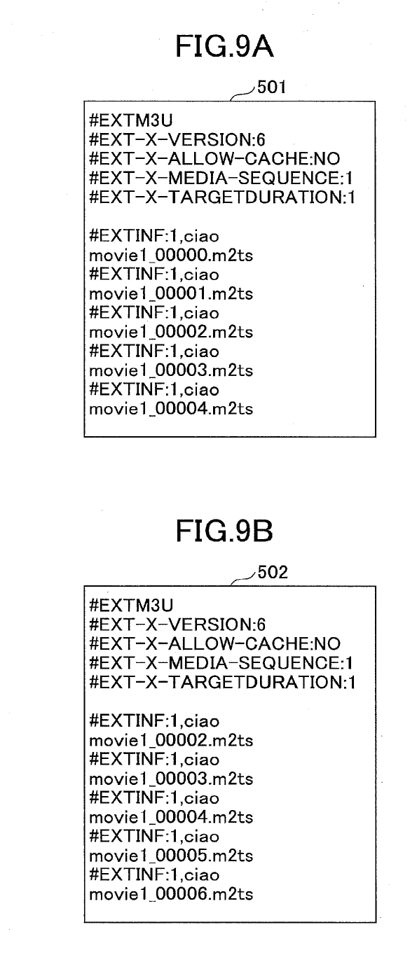

Next, with reference to FIG. 8, an example of playlist generation process by the playlist generation unit 15 will be described in detail. FIG. 8 is a diagram depicting an example of a flowchart of the playlist generation process.

When receiving the playlist acquisition request from the client terminal 20 (step S201), the playlist generation unit 15 refers to the reproduction history information 111, and acquires an acquisition number of times associated with the client terminal 20 and a playlist (step S202). When there are not data associated with the client terminal 20, an ID of the client terminal 20 and an initial value “1” for the acquisition number of times are stored in the reproduction history information 111.

Referring to the segment information 113, the playlist generation unit 15 determines whether there is a segment removed from the segment information 113 among segments described in the playlist associated with the client terminal 20 (step S203).

When there is not a segment removed from the segment information 113 (step S203: NO), the playlist generation unit 15 ends the process.

When there is a segment removed from the segment information 113 (step S203: YES), the playlist generation unit 15 removes the segment from the playlist (step S204).

Referring to the playlist generation information 112, the playlist generation unit 15 acquires a time unit of segments associated with the acquisition number of times (step S205).

Referring to the segment information 113, the playlist generation unit 15 determines whether there is a file, a start time of which coincides with an end time of the final segment in the playlist, in the set of segments of the time unit acquired at step S203 (step S206).

When there is not a file, a start time of which coincides with an end time of the final segment in the playlist (step S206: NO), the playlist generation unit 15 extracts, from a set of segments of time unit, smaller than the time unit by one, a segment, a start time of which is equal to the end time of the final segment, and adds the segment to the end of the playlist (step S207). Then, the process proceeds to step S209.

When there is a file, a start time of which coincides with the end time of the final segment in the playlist (step S206: YES), the playlist generation unit 15 extracts, from the set of the time unit, a segment, a start time of which is equal to the end time of the final segment, and adds the segment to the playlist (step S208).

Next, the playlist generation unit 15 determines whether a number of segments described in the playlist reaches a predetermined number (step S209).

When the number of segments does not reach the predetermined number (step S209: NO), the process returns to step S208. When the number of segments reaches the predetermined number (step S209: YES), in the reproduction history information 111, the playlist generation unit 15 increases the acquisition number of times associated with the client terminal 20 by one, stores information of the generated playlist in association with the client terminal 20 (step S210), and ends the process.

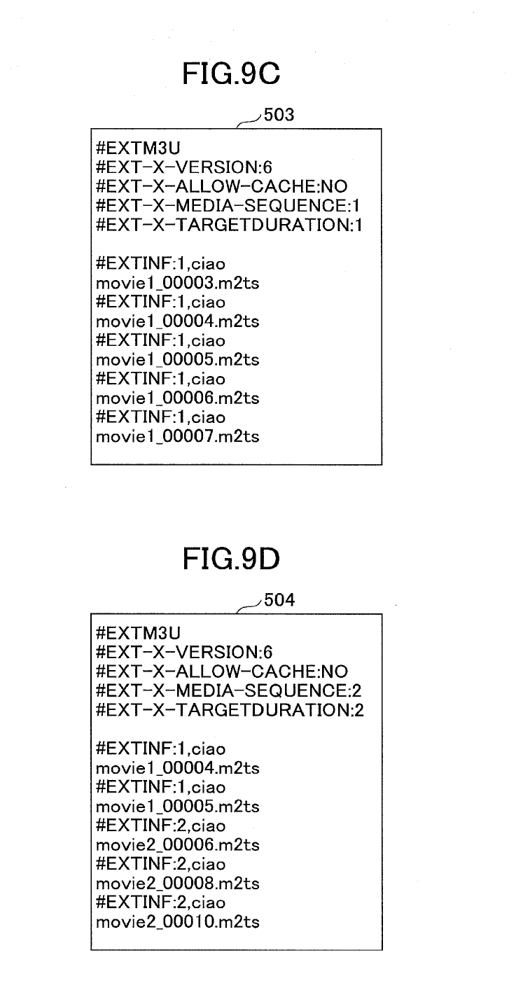

Next, with reference to FIGS. 9A to 9E, contents of playlist that the server apparatus 10 delivers when HLS is used will be described. FIGS. 9A to 9E are diagrams depicting an example of contents of the playlist. FIGS. 9A to 9E illustrate an example of contents of the playlists 501, 502, 503, 504 and 505 in the flowchart of FIG. 7, when the client terminals 20-1, 20-2, and 20-3 first acquire playlists from the server apparatus 10. Here, as an example, a case will be described where the playlist generation information 112 is set as illustrated in FIG. 5, and the segment information 113 is recorded as illustrated in FIG. 6.

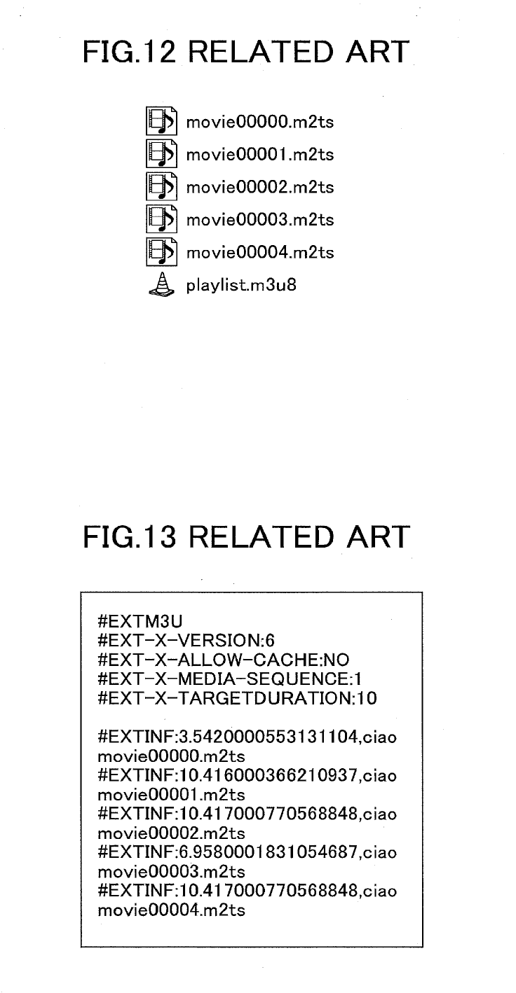

An “EXTM3U” tag in each playlist indicates that the playlist is in the extended M3U file format. An “EXT-X-VERSION” tag indicates information of the version having compatibility. An “EXT-X-ALLOW-CACHE” tag indicates designation whether a downloaded segment may be cached in order to replay later. An “EXT-X-MEDIA-SEQUENCE” tag indicates a media sequence number of a first segment of a playlist. An “Ext-X-TARGETDURATION” tag indicates an integer value which is greater than or equal to the maximum reproduction time of segment included in a playlist. An “EXTINF” tag indicates reproduction time and a title of each segment indicated by a URI following the tag. In FIGS. 9A to 9E, in order to simplify an explanation, a reproduction time of each segment is indicated by an integer. But, actually, because files are divided so that key frames come to beginnings, in the same way as the related art illustrated in FIG. 13, the reproduction time of each segment includes a value after the decimal point.

FIG. 9A depicts an example of content of the playlist 501 generated when the delivery of content starts. The playlist 501 illustrated in FIG. 9A describes a plurality of segments, where start time is from 0 seconds to 4 seconds and a sum of reproduction times is 5 seconds, in a set of time units of segments of a second.

FIG. 9B depicts an example of content of the playlist 502 generated when two seconds elapse after the delivery of contents starts. The playlist 502 illustrated in FIG. 9B describes a plurality of segments, where start time is from 2 seconds to 6 seconds and a sum of reproduction times is 5 seconds, in a set of time units of segments of a second.

FIG. 9C depicts an example of content of the playlist 503 generated when three seconds elapse after the delivery of contents starts. The playlist 503 illustrated in FIG. 9C describes a plurality of segments, where start time is from 3 seconds to 7 seconds and a sum of reproduction times is 5 seconds, in a set of time units of segments of a second.

FIG. 9D depicts an example of content of the playlist 504 of the second time generated when four seconds elapse after the delivery of contents starts. The playlist 504 illustrated in FIG. 9D describes a plurality of segments, where start time is from 4 seconds to 5 seconds, in a set of time units of segments of a second, and start time is from 6 seconds to 10 seconds, in a set of time units of segments of two seconds, and a sum of reproduction times is 8 seconds.

FIG. 9E depicts an example of content of the playlist 505 of the third time generated when ten seconds elapse after the delivery of contents starts. The playlist 505 illustrated in FIG. 9E describes a plurality of segments, where start time is 10 seconds, in a set of time units of segments of two seconds, and start time is from 12 seconds to 24 seconds, in a set of time units of segments of four seconds, and a sum of reproduction times is 18 seconds.

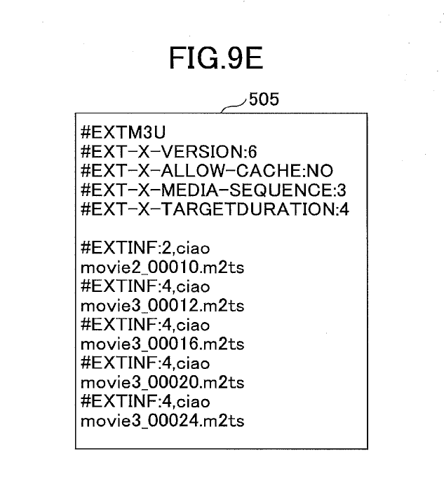

Next, with reference to FIG. 10, the operation of delivering files of segments in the delivery system 1 according to the embodiment will be described. FIG. 10 is a diagram depicting an example of a sequence of delivering files of segments in the delivery system 1 according to the embodiment.

When acquiring a playlist from the server apparatus 10, the client terminal 20-1 sends an acquisition request for a file of a first segment at a beginning of the playlist (step S301).

The server apparatus 10 sends a file of the requested segment to the client terminal 20-1 (step S302).

The client terminal 20-1 reproduces the file of the requested segment acquired from the server apparatus 10 (step S303).

The client terminal 20-1, in parallel with reproducing, sends to the server apparatus 10 an acquisition request for a file of a second segment described in the playlist 501 (step S304).

The server apparatus 10 sends to the client terminal 20-1 a file of the segment that is required (step S305).

The client terminal 20-1 stores the file of the segment acquired from the server apparatus 10 (step S306). Then, when reproduction of a file of segments acquired previously ends, the file of the segment acquired this time is reproduced (step S307).

The client terminal 20-1 repeats the acquisition and storage of a file of segments, in the same way as steps S304 and S305, until a file of the final segment described in the playlist 501 is acquired (step S307, step S308, step S310, and step S311). Then, in the same way as step S306, when reproduction of a file of the previous segment ends, a file of the next segment is reproduced (step S309, step S312).

After completion of acquisition of files of all segments, when reproduction of the files of all segments ends, the client terminal 20 ends reproduction of videos or the like.

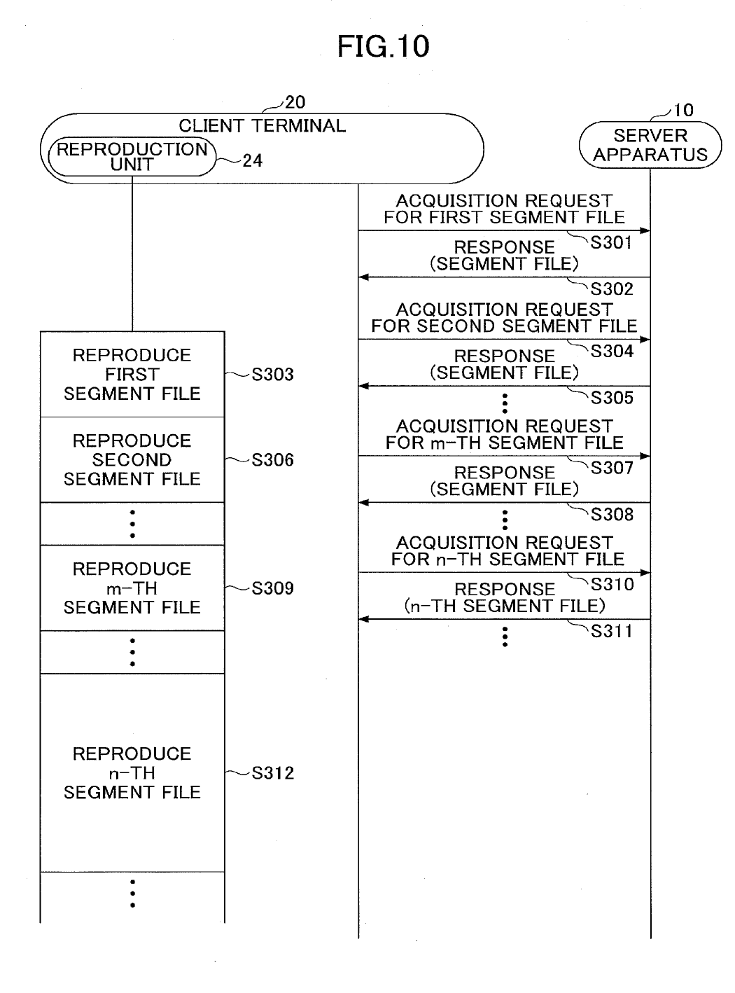

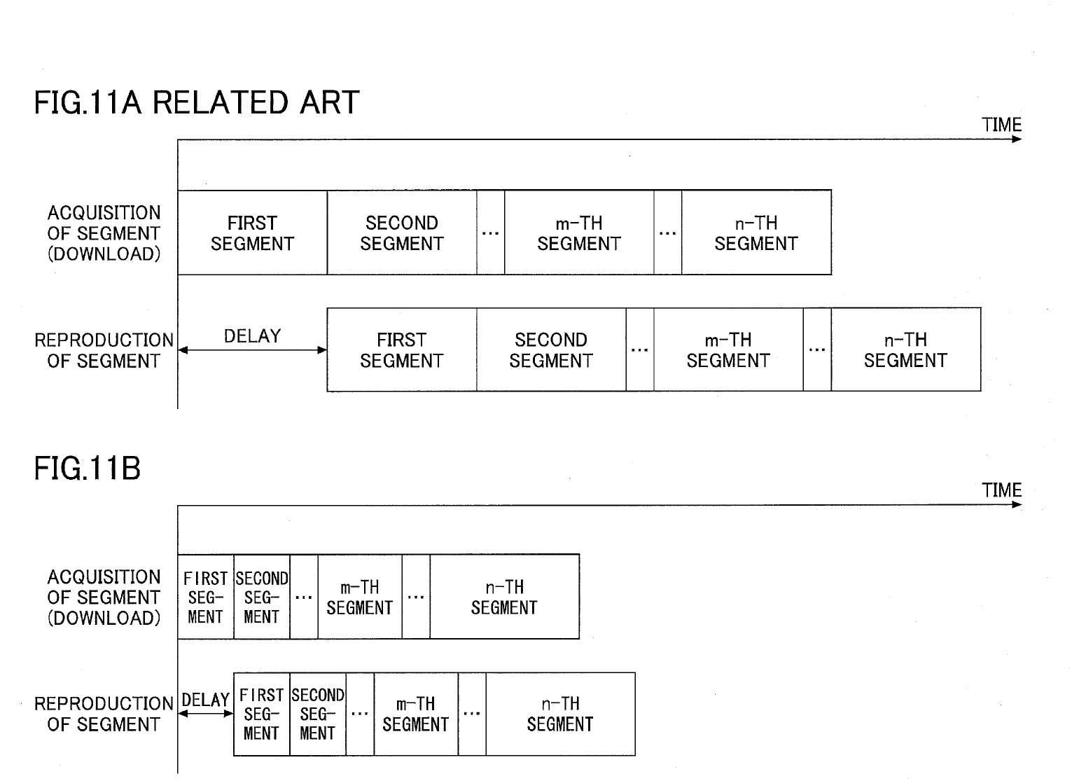

Next, referring to FIGS. 11A and 11B, delays of reproduction time in the related art and in the embodiment will be described. FIGS. 11A and 11B are diagrams for explaining delays of reproduction time in the related art and in the embodiment. FIG. 11A is a diagram depicting an example of timings at which the client terminal 20 acquires respective segments and timings at which the client terminal 20 reproduces the respective segments in the related art. When completing acquiring the first (beginning) segment described in the playlist, the client terminal 20 starts reproducing the first segment, then serially acquires and reproduces second and further segments described in the playlist. Therefore, the delay of the reproduction time includes a network delay upon acquiring the first segment or the like, in addition to delays upon encoding contents in the server apparatus 10 or the like.

FIG. 11B is a diagram depicting an example of timing at which the client terminal 20 acquires respective segments and timings at which the client terminal 20 reproduces the respective segments in the embodiment. When completing acquiring the first (beginning) short segment described in the playlist, the client terminal 20 starts reproducing the first segment, then serially acquires and reproduces second and further segments described in the playlist. Therefore, because the network delay or the like upon acquiring the segment in the beginning of reproduction is reduced, the delay of the reproduction time is reduced.

<Effects>

In the real-time distribution, when the segment to be delivered is made longer, the network delay upon the network delivery increases, and the delay until the reproduction starts in the client terminal 20 increases. Moreover, the time from acquiring a segment until starting reproduction application in the client terminal 20 or the like is also added to the delay. Then, because the delay that occurs is not removed also in further reproduction of contents, real-time property in the real-time distribution may be degraded. That is, a delay from capturing contents, for example, by a camera until being reproduced in the client terminal (delay of reproduction time) increases. In contrast, when the segment is made shorter, an update number of times for a playlist by the client terminal 20 increases, and a load on the client terminal 20 or the server apparatus 10 grows.

In the embodiment, described as above, the server apparatus 10 provides to the client terminal 20 a playlist in which a short segment is described in the beginning of the reproduction of contents. Therefore, a delay upon delivering the segment via a network by the client terminal 20 is reduced, and a delay until reproduction starts in the client terminal 20 is reduced. Then, also in the further reproduction of contents, the reduced delay is maintained, and the real-time property in the real-time distribution is enhanced. That is, the delay of the reproduction time is reduced.

In the embodiment, described as above, the server apparatus 10 provides a playlist describing a long segment to the client terminal 20 after the reproduction of contents proceeds to a certain extent. Therefore, the updating number of times for a playlist by the client terminal 20 does not increase, and growth of the load on the client terminal 20 or the server apparatus 10 can be suppressed.

Moreover, in the embodiment, described as above, files of segments are generated so that a start time and an end time of one file included in a set of segment files divided in a long time unit are equal respectively to a start time of a first file and an end time of a second file among a plurality of files included in a set of segment files divided in a short time unit. Therefore, when the segment set is switched in the middle, contents are neither duplicated nor lacking. Accordingly, discontinuity or the like of video does not occur.

<Variation>

In the embodiment, described as above, an example where the acquisition number of times (number of times of acquiring a playlist) is used as the reproduction history. However, instead of the acquisition number of times, for example, a sum of lengths of the respective segments reported in the playlist, a sum of lengths of the respective segments delivered from the segment file delivery unit 16 to the client terminal 20, a continuous reproduction time reported from the client terminal 20 or the like may be used. In this case, the playlist generation unit 15 may describe a set of longer segments in the playlist, when a value of the sum or the continuous reproduction time becomes greater than or equal to a predetermined threshold, for example.

In the server apparatus 10, instead of managing the reproduction history for each client terminal 20, the reproduction history may be reported from the client terminal 20. In this case, the client terminal 20 may report such information to the server apparatus 10 by using a “Cookie” or the like, and the server apparatus 10 may generate the playlist based on the reported information.

The server apparatus 10 may be configured with a plurality of information processing apparatuses. For example, the segment file delivery unit 16 may be configured with a separated device coupled via a network such as in cloud computing.

In the related art, when the respective segments are made longer, there is a problem that a delay from capture or the like of content by using a camera for reproduction in the client (delay of reproduction time) becomes greater.

In contrast, when the respective segments are made shorter, although the delay of reproduction time becomes smaller, there is a problem that frequency of acquisition requests for segments from the client to the server increases, and thereby a load on the server or the like becomes greater.

According to the disclosure of the present invention, the delay of reproduction time in the streaming delivery can be reduced and an increase of a load on the server by high-frequency acquisition request for segment from the client can be suppressed.

Further, the present invention is not limited to these embodiments, but various variations and modifications may be made without departing from the scope of the present invention.

What is claimed is:

1. An information processing apparatus, to which a client terminal is coupled, the apparatus comprising:
a segment generation unit configured to generate a first set of segments, in which content is divided into a plurality of first segments in accordance with a first time unit, and a second set of segments, in which the content is divided into a plurality of second segments in accordance with a second time unit, which is greater than the first time unit;
a playlist generation unit configured to select one of the first segments and the second segments based on a reproduction history of the content in the client terminal, and generate a playlist including information on the selected segments; and
a playlist delivery unit configured to deliver the playlist to the client terminal.

2. The information processing apparatus according to claim 1,
wherein the playlist generation unit is configured to select the second segments, when the reproduction history is greater than or equal to a predetermined threshold.

3. The information processing apparatus according to claim 1,
wherein the reproduction history is any one of a number of times that the client terminal acquires the playlist, a sum of lengths of segments information of each of which is included in the playlist, a sum of lengths of segments delivered to the client terminal based on the playlist, and a continuous reproduction time reported from the client terminal.

4. The information processing apparatus according to claim 1,
wherein the segment generation unit is configured to generate the first set of segments and the second set of segments so that a start time and an end time of a segment of a file included in the second set of segments are the same as a start time of a segment of a first file and an end time of a segment of a second file included in the first set of segments, respectively.

5. The information processing apparatus according to claim 1,
wherein the playlist generation unit is configured to delete the reproduction history, when a predetermined time elapses after the client terminal acquires the playlist.

6. A delivery method for delivering content to a client terminal, the method comprising:
generating a first set of segments, in which the content is divided into a plurality of first segments in accordance with a first time unit, and a second set of segments, in which the content is divided into a plurality of second segments in accordance with a second time unit, which is greater than the first time unit;
selecting one of the first segments and the second segments based on a reproduction history of the content in the client terminal, and generating a playlist including information on the selected segments; and
delivering the playlist to the client terminal.
